(19) United States
(12) Patent Application Publication
(10) Pub. No.: US 2004/0203620 A1
(43) Pub. Date: Oct. 14, 2004

(54) Method and apparatus for time stamp of electronic message

(76) Inventors: Timothy Thome, Spring Valley, CA (US); Anand Janakiraman, San Diego, CA (US)

Correspondence Address: Kyocera Wireless Corp., Attn: Patent Department, PO Box 928289, San Diego, CA, 92192-8289, US

(21) Appl. No.: 10/271,493

(22) Filed: Oct. 15, 2002

(51) Int. Cl. H04M 3/42

(52) U.S. Cl. 455/412.1; 455/414.1

(57) ABSTRACT

A method and apparatus is disclosed for time stamping an electronic message to accurately associate time information with the electronic message. The time information may identify the time at which the message was sent or processed. In one embodiment the time information comprises a time stamp value, a time offset value, a time convention identifier for the time stamp, and a daylight savings time identifier. These values maybe by appended by a message center prior to sending the message to a message recipient. Upon receipt by a mobile communication device, processing occurs so that an accurate message sent time is provided. In one embodiment a system time, from a communication system, is continually provided to the mobile communication device to thereby allow display of the message sent time value in a format corresponding to the location, i.e. time zone, of the mobile communication device at the time of receipt.

### FIELD OF THE INVENTION

The invention relates generally to electronic messaging and in particular to a method and apparatus to time stamp an electronic message.

### RELATED ART

Electronic messaging has become a popular system to communication with friends, co-workers, or other contacts. The term electronic messaging may refer to text messages, voice mail messages, short message service, enhanced message service, multimedia messaging, alerts and pages.

To send an electronic message, a user either speaks, types, or otherwise selects data to form the electronic message. While it is understood that the term electronic message is not limited to an electronic message typed in by a user, for purposes of understanding, the examples discussed herein refer to messages that are text based. It is contemplated that the drawbacks associated with text messages may apply to all types of electronic messaging. Upon completing the message, the user takes steps to send the message to the recipient. The message is sent over one or more communication mediums or channels to a recipient's electronic device. The recipient may then read the message, which may be displayed on a screen. In the case of a voice message the recipient would listen to the message.

In many cases the communication devices at the message center that process the electronic message also include, with the message, information regarding the time and date that the message was sent. As can be understood, a recipient may have an interest in knowing when, i.e. at what time, the message was sent. This information may be processed to provide a message recipient information regarding when a message was sent.

While systems of the prior art associate time information with an electronic message, the time information that was associated with prior art messages was often incorrect. This is a significant drawback. Indeed, incorrect time information is often worse than failure to associate any time information with the electronic message. For example, if incorrect time information is associated with the message, then improper assumptions may be made based on the incorrect time information.

Association of incorrect time information with a message or an inability to determine when a message was sent may arise for several reasons. One such reason is that the time at a message processing center may not be properly set. In systems of the prior art, technical personnel at message centers often fail to properly set the time of their equipment or fail to set the time to correspond to the proper time zone convention. This results in an incorrect time being associated with an electronic message.

While time inaccuracies are problematic for non-portable devices, such as desktop computers, attempting to determine when a message was sent by a user of a portable communication device can be daunting. The recipient of a message sent from an individual using a portable communication device may be unaware of the location of the sending individual when the message was sent. The sender may be traveling cross-country at the time of sending and thus the task of determining the time when the electronic message was sent may be impossible. Moreover, the several factors discussed above may combine to make it impossible for the recipient to mentally perform calculations to determine the time when the message was sent. If the time at which a message is sent is not available then the worth of electronic messaging is severely diminished. By way of example, when a message was sent may have an impact on a decision or the eventual outcome of an event.

For example, the current CDMA (code division multiple access) SMS (short message service) standard, as contained in IS637, contemplates including the time of receipt at a message center into an outgoing SMS electronic message. This system of time stamping, as described in IS637, while attempting to provide a solution, suffers from many drawbacks and does not adequately address the complexity presented to a user attempting to determine when a message was sent. One such drawback is that a recipient of an SMS electronic message may be unable to reliably and accurately determine the time that a message was sent.

As a result of the drawbacks in the prior art there exists a need for a method and apparatus to accurately and efficiently time stamp an electronic message.

### SUMMARY

The method and apparatus described and claimed herein provides an efficient and accurate time stamp for an electronic message. FIG. 1 illustrates a block diagram of an example environment of use of the invention. FIG. 1 and the discussion that follows are helpful in understanding the invention. As can be understood, one benefit of electronic messaging is an ability to rapidly send messages to users who may be traveling at various locations around the United States or the World. As shown, a first mobile station 104 and a second mobile station 108 communicate with base stations 112, 116. The base station 112 may communicate with a communication switch 120 when providing data to or receiving data from a first message center 124.

Alternatively, a base station, such as base station 116, may communicate directly with a message center, such as a second message center 128. In the configuration shown in FIG. 1, the first mobile station 104 is associated with the first message center 124. Association of a mobile station with a message center contemplates that messages generated and sent by a mobile station are sent to its associated message center for processing. The processing may include inclusion of time information with the message.

It is contemplated that communication may occur between mobile stations 104, 108, or between mobile stations and a non-mobile communication device 150. Although not required, the principles discussed herein are particularly beneficial if the receiving unit is a mobile unit.

To exchange messages between mobile stations 104, 108 the second message center 128 may communicate with a switch 132. The switch 120 and switch 132 may communicate directly as shown or over some form of data network 136. In this manner a user of the first mobile station may generate and transmit an electronic message to a user of the second mobile station. To achieve such an exchange, the first mobile station 104 generates a message and transmits it over a communication channel, such as a wireless link 140 to the base station 112. The base station 112 transfers the electronic message to the first message center 124 via the switch 120 since the first mobile station is associated with the first message center.

The first message center 124 processes the electronic message into a format for transmission to the second mobile station and may append time information to the electronic message. The message centers may contain one or more databases containing information regarding the users of the electronic messaging system. After processing, the first message center 124 transmits the electronic message to the second message center 128 in any feasible manner such as via switches 120, 132 or a data network 136. The second message center 128 forwards the message to an appropriate base station 116 that in turn forwards the message over a communication channel 140 to the second mobile station 108.

As can be seen from FIG. 1, the first mobile station 104 may be located in a different time zone than the second mobile station 108. In the continental United States there exists a Pacific Standard Time Zone, offset 8 hours from UTC, a Mountain Standard Time Zone, offset 7 hours from UTC, a Central Standard Time Zone, offset 6 hours from UTC, and an Eastern Standard Time Zone offset 5 hours from UTC. UTC is defined as Universal Coordinate Time, also known as Greenwich Mean Time (GMT), Zulu time, universal time, and world time. UTC is a time reference notation having 24 values.

When an electronic message is sent from the first mobile station 104 to the second mobile station 108, time information may be attached to the electronic message by the first mobile station or the first message center 124. Because the time information is attached by the either of these devices, the time the message was sent and the time zone that corresponds to that time may be recorded with the message and provided to the message recipient. As an advantage of the invention over the prior art, the user of the second mobile station 108 is thus able to determine when the message was processed by the first message center. As a result, the user of the second mobile station is able to generally determine when the message was sent.

As described above in the background, in systems of the prior art the user of the second mobile station 108 was unable to determine when the message was sent. As can be understood, it is possible that the time on the message could be provided as the time of the time zone in which the first mobile station 104 is located, i.e. Mountain time zone, or the time zone in which the first message center is located, or even the central time zone where the second mobile station 108 and the second message center 128 are located. In contrast to systems of the prior art, the method and apparatus described and claimed herein provides a user accurate time information.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

FIG. 1 is a block diagram illustrating a geographic area containing different time zones and various electronic communication devices.

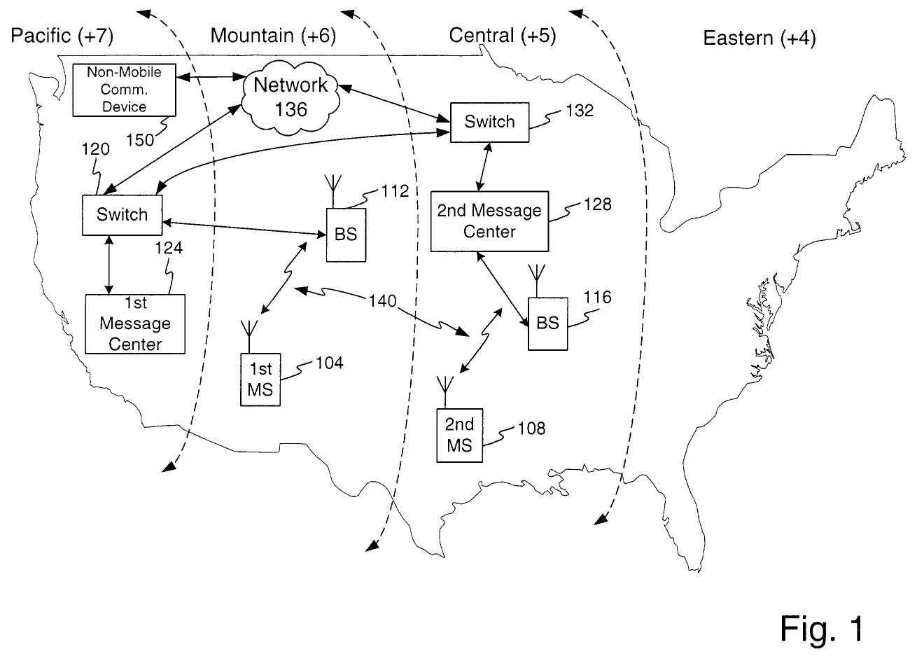

FIG. 2 is a block diagram illustrating an example embodiment of a mobile station.

FIG. 3 is block diagram illustrating an example embodiment of base station and a message center.

FIG. 4 in example of an electronic message.

FIG. 5 is an operational flow diagram of an example method of message generation.

FIG. 6 illustrates exemplary fields of an exemplary message.

FIG. 7 is an operational flow diagram of an example method of operation upon receipt of an electronic message.

FIG. 8 is an operational flow diagram of an example method of time calculation when system time is available.

### DETAILED DESCRIPTION

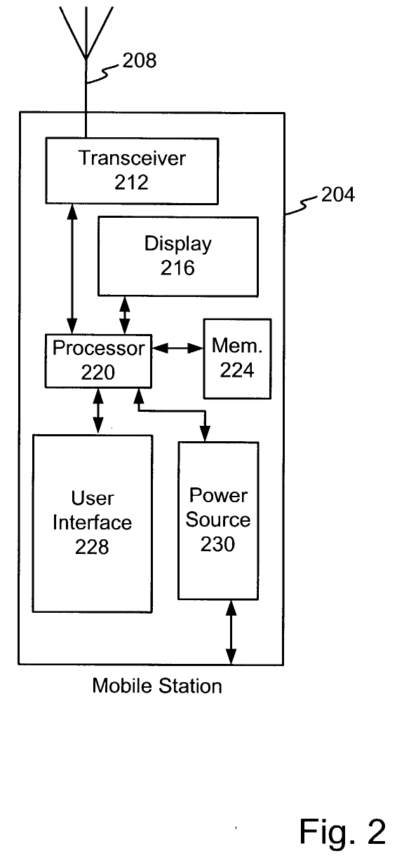

FIG. 2 illustrates a block diagram of an example embodiment of a mobile station. Other configurations of a mobile station are contemplated and the time stamping principles as described herein may apply to these other configurations or to any portable communication device. Examples of portable communication devices comprise wireless telephones, pagers, personal digital assistants, laptop computers, and the like. In this example embodiment the mobile station 204 includes an antenna 208 connected to a transceiver 212. The transceiver 212 connects to a processor 220. The processor 220 serves as the control center for the mobile station 204 by connecting and communicating with the transceiver 212, a display 216, a memory 224 and a user interface 228. One or more types of memory 224 may be utilized including, but not limited to, RAM, ROM, flash memory, magnetic memory, magnetic memory, such as a micro-hard disk drive, or optical memory. A power source 230, such as battery or connection of an external power source, provides power to the electronic systems of the mobile station 204. The display 216 may comprise any type of device capable of displaying information including but not limited to and LED (light emitting diode) screen, a LCD (liquid crystal display) screen, a plasma display, a CRT (cathode ray tube), a TFT (thin film transistor) screen, and an active matrix display or a combination thereof. The user interface 228 may comprise any device(s) or system(s) configured to obtain information or data from a user or provide data to a user. Examples may include but are not limited to a keypad or keyboard, touch screen, microphone, speaker, or writing pad.

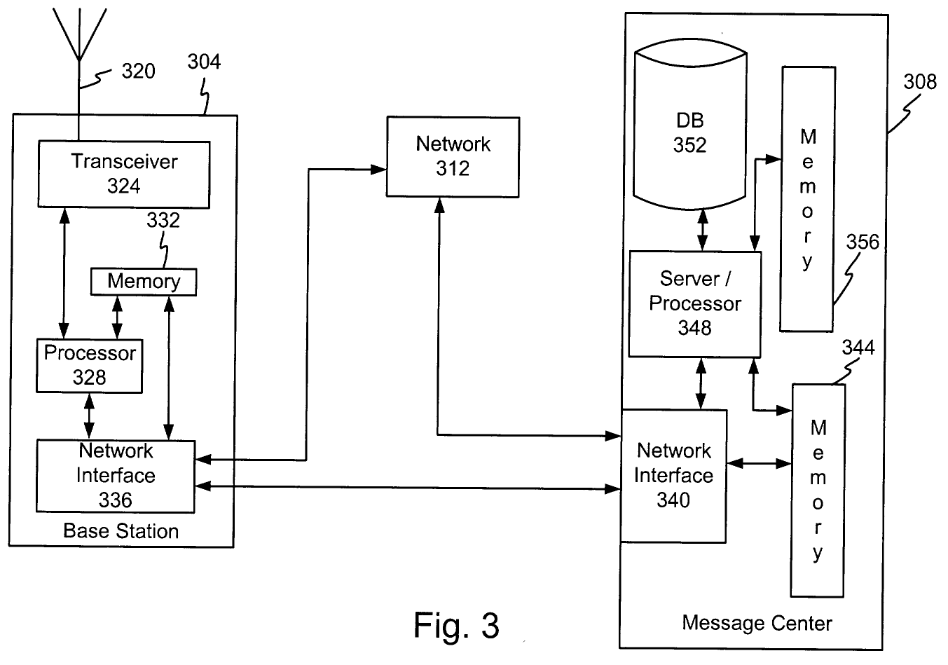

FIG. 3 illustrates a block diagram of an example embodiment of a base station and exemplary connection to a message center. In one embodiment the base station 304 comprises a communication site configured to communicate with a plurality of mobile stations. In one example embodiment the base station 304 comprises a cell site. The base station 304 communicates with a message center 308 either directly or via a network 312. Any type of data or communication network 312 may be configured to provide communication between the base station 304 and the message center 308. One example is a network configured in accordance with the SONET/SDH protocol.

In the example embodiment shown in FIG. 3, the base station includes an antenna 320 connected to a transceiver 324. The transceiver 324 connects to a processor 328, which in turn connects to a memory 332 and a network interface 336. The network interface 336 is responsible for communication with the message center 308 as shown.

The message center comprises any type or number of computers or other electronic devices configured to process electronic messages. In one embodiment the message center 308 comprises a network interface 340 configured to communicate with one or more base stations 304. The network interface 340 connects to a memory 344 and a server/processor 348. The server/processor 348 stores and retrieves data from a database 352. Memory 356 is associated with the processor 348. Any type of memory may be utilized including RAM, ROM, hard disk drive memory, or optical memory. In one embodiment the message center 308 is responsible for associating time information with an electronic message. Software code or other processor executable instructions may reside on the database 352 or memory 356 for execution by the server/processor 348. Operation of the message center 308 and the processor executable instructions are discussed below in more detail as related to the invention.

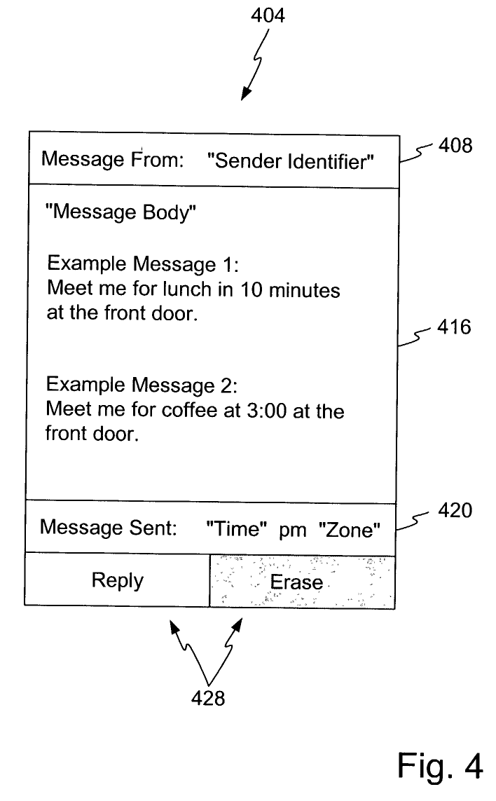

FIG. 4 illustrates an example configuration of a screen shot of an electronic message. Although the electronic message is illustrated in FIG. 4 as a text based message, it is contemplated that an electronic message may comprise a voice message or other type of format. In this example embodiment the electronic message 404 comprises a sender identifier field 408, a message body field 416, a time data field 420 and a reply/erase option field 428. The sender identifier field 408 comprises a portion of the message that indicates who sent the message. The message body field 416 comprises a portion of the message that contains the message, such as a text message or other information. Examples are shown in FIG. 4 for purposes of understanding to highlight the importance of associating accurate time information with the message 404. The time data field 420 comprises a portion of the message that indicates when the message was sent. A message recipient may optionally reply or erase the message using reply/erase option field 428. In operation, a message recipient may determine when the message was sent by viewing the time data field 420.

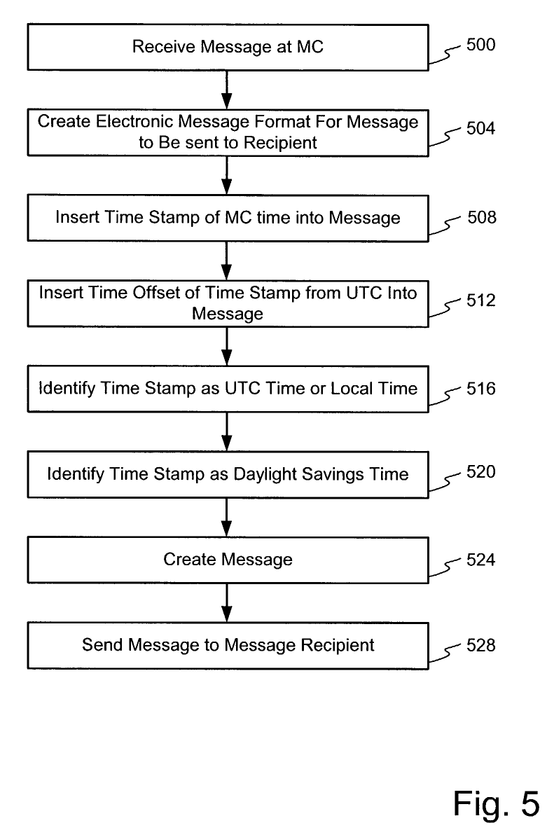

FIG. 5 illustrates an operational flow diagram of an example method of message construction for a message, which includes supplemental time stamp information. In the example embodiment described herein the message center associated with the message sender constructs or formats at least part of the message prior to sending the message to the message recipient. In other embodiments, other methods of operation may occur for message construction or formatting. This process may occur at a location or device different than the message center.

At a step 500, the message center (‘MC’) receives a message. The message may be received from a mobile station or other device including a desktop computer, network, or communication system. After receipt of the message, the message center may create a message shell. This occurs at a step 504. It is contemplated that the message as received by the message center may comprise recipient data, sender data, or message body data. Recipient data and sender data may comprise an address, telephone number, or other routing identifier.

Next, at a step 508, the message center inserts the time stamp of the message center time into the message. The message center time may be local time or UTC (Universal Coordinate Time) time. At a step 512 the message center inserts time offset data regarding the time stamp into a time offset field of the message. In one embodiment the time offset data comprises the time offset, from UTC time, of the message center. For example, a message center located in New York, N.Y. would be offset 8 hours since New York is 8 hours (standard time) ahead of the UTC time zone. The time units may be expressed in ½ hour increments or other units to account for certain time zones that adjust in ½ hour increments.

At a step 516 the message center identifies in a UTC/Local time field of the message whether the message time stamp is in UTC time or local time. Whether the message center time is set to UTC time or local time may be referred to as time convention. Other time formats may be utilized in other embodiments. It is contemplated that the message center time may be set to UTC time or the local time associated with the location of the message center. Thereafter, at a step 520, the message center identifies, within the message, whether the time stamp is adjusted for daylight saving time (‘D.S.T.’). The time setting of the message center may be adjusted for daylight saving time, and hence the time stamp may reflect such adjustment. Inclusion of daylight time adjustment may be necessary to decode the true time when the message was sent.

At a step 524 the message center, having populated the potential fields of the message, creates the message. As is contemplated, at a step 528 the message center takes steps to send the message to the message recipient. The message may be sent immediately, or stored for sending at a later time, such as when the message recipient checks their messages or when their mobile communication device gains access to a network.

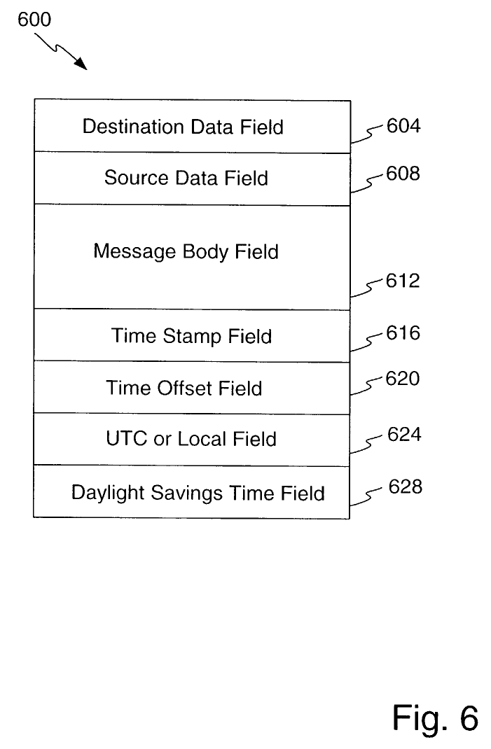

FIG. 6 illustrates exemplary contents of a message. This is but one possible message configuration and other configuration are within the scope of the claims that follow. Moreover, the message may be constructed with more or fewer fields than shown while still enjoying the benefits described herein. The message shown in FIG. 6 comprises a destination data field 604, a source data field 608, a message body field 612, a time stamp field 616, a time offset field 620, a UTC/local time field 624 and a daylight saving time identifier field 628.

The destination data field 604 may contain data regarding the destination or recipient of the message. This may comprise an address, telephone number, alpha string, e-mail address, IP address, or a numeric string other than a telephone number. The source data field 608 may contain data regarding the source or sender of the message. This may comprise an address, telephone number, alpha string, e-mail address, IP address, or a numeric string other than a telephone number. The message body field 612 may contain data, i.e. the message being sent. It may be of any length or size and may include text, graphics, pictures, audio, video, or other format of data. The time stamp field 616 may contain data regarding the time at which the message was sent or when the message was received by the message center or other processing location. It is further contemplated that the time stamp may comprise other time data.

The time offset field 620 may contain data regarding an offset or difference between the time stamp data, such as the time stamp time, and one or more reference times. In one embodiment the time offset field 620 contains an numeric offset value between the time stamp and zero reference for UTC time. In one embodiment the time offset field 620 indicates a time zone of the time stamp.

The UTC/local time field 624 may contain data regarding whether the time stamp represents UTC time, the local time in which the message center is located, or a different time representation system. The daylight saving time identifier field 628 may contain data regarding whether the data in the time stamp field has been adjusted for daylight saving time. Other adjustments may also be noted. Any one or more of these fields may be populated. These fields may be of any size. In one embodiment the fields may be of the following size: the message body field 612 may be any size to accommodate the message bits, the time stamp field 616 is 8 bits, the time offset field 620 is 6 bits, the UTC/local time field 624 is 1 bit and the daylight saving time field 628 is 1 bit.

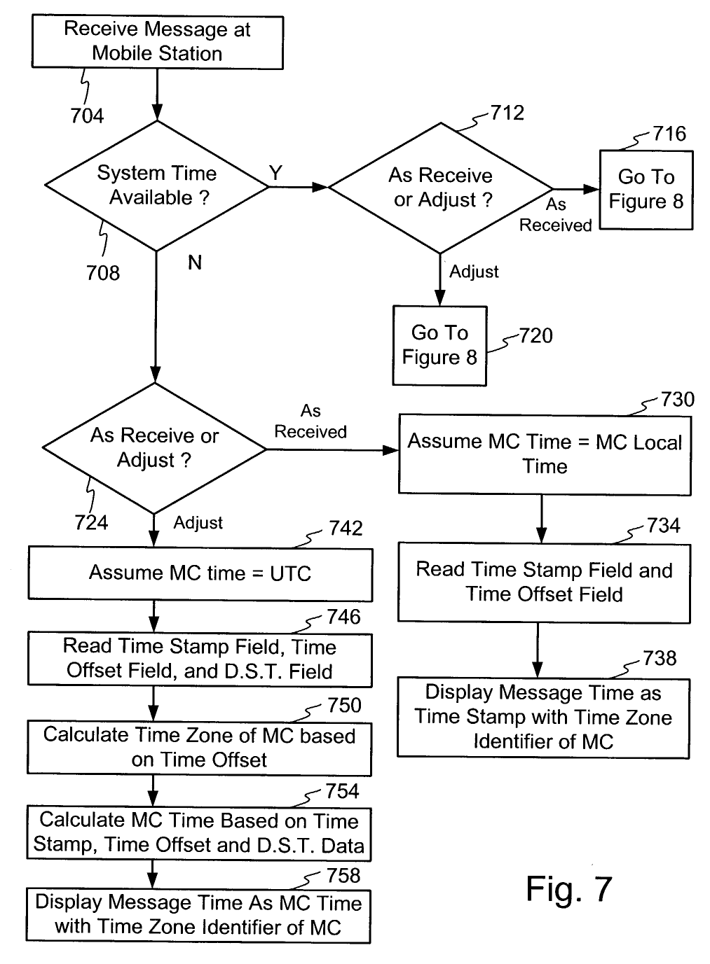

FIG. 7 illustrates an operational flow diagram of a method of operation upon receipt of an electronic message. In one embodiment the goal of the method shown in FIG. 7 is to provide or display to a message recipient the time that the message was sent in such a way so as to allow the recipient to truly determine when the message was sent. In accordance with the invention, the message may contain data in one or more fields shown in FIG. 6. In one embodiment this method occurs in the receiving mobile station although in other embodiments it is contemplated that this method may occur in or at another device or location. At a step 704, the mobile station receives the message. Any manner of reception is contemplated. Thereafter, at a step 708, the method determines if system time is available. System time refers to time information received by the receiving mobile station from a sending mobile station regarding the time at the location of the sending mobile station's message center. For example, in code division multiple access (CDMA) systems a sync channel controls timing of the other channels to achieve the multiple access aspects of CDMA. The mobile station thus may have access to system time.

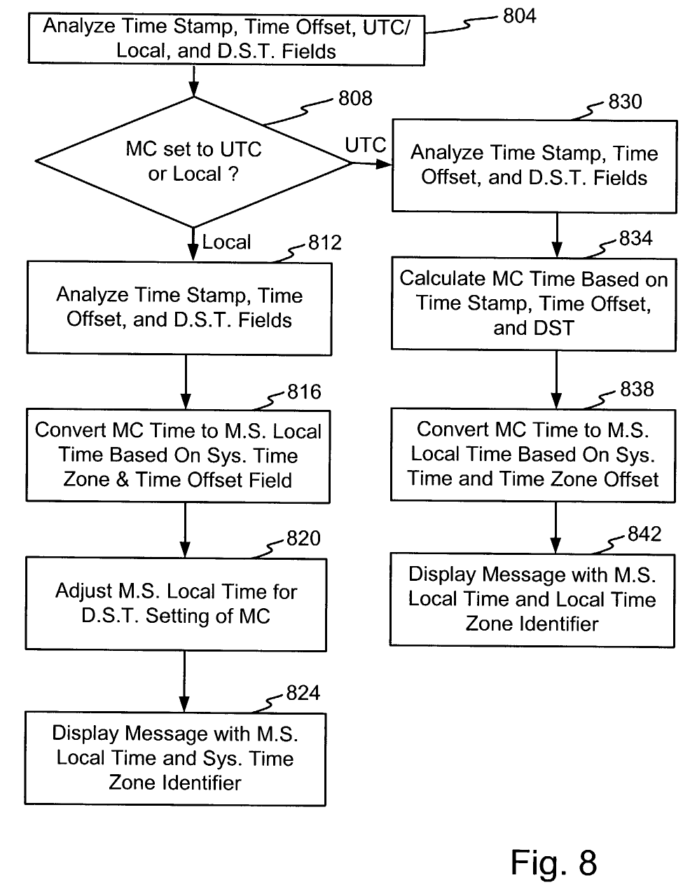

If at step 708 the system time is available, then operation proceeds to step 712. At step 712 the operation determines whether the time should be displayed as received or to adjust the time. This step may be considered optional in that only certain mobile stations may be configured with the option to process the message time on an as received or adjusted basis. The term ‘as received’ is defined to mean that the time information is displayed or provided to a recipient as it was received. The term or process ‘adjust’ is defined to mean that the time information is adjusted, to the extent possible, to provide time information to the message recipient in a more desirable format. While in other embodiments the as received option and the adjust option may be handled differently, the present embodiment handles both processing options, shown at steps 716 and 720, in an identical manner which is described below in conjunction with FIG. 8.

Alternatively, if at step 708 system time is unavailable then the method or operation proceeds to step 724 wherein a determination is made regarding whether the mobile station is configured to display the message sent time as received or to adjust the message sent time. This step may be considered optional in that only certain mobile stations may be configured with the option to selectively process the message time on an as received or adjust basis. If at step 724 the mobile station is set to display the time as received, the operation advances to step 730 wherein it is assumed that the message center (MC) time is equal to or set to the local time of the message center. Thereafter, at a step 734, mobile station reads the data in the time stamp field and the time offset field and, at a step 738, displays the message time as the time stamp value and further displays the time zone identifier, which may be calculated by the value in the time offset field. Daylight saving time information may optionally be displayed or provided in the message time to alert the user that the message has accounted for daylight saving time. The end result of step 738 is that the user receives a message indicating the time value (time stamp), which is the message center time, and what time zone the time value is associated with and optionally whether the values are adjusted for daylight savings time.

In contrast, if at step 724 the mobile station is set to adjust the time, then the operation advances to step 742 and the operation or processing assumes that the message center time is set equal to or represents UTC time. Next, at a step 746, the operation reads the data in the time stamp field, the time offset field, and the daylight savings time (D.S.T.) field. Inclusion of this data in the message provides the advantage of being able to display the proper message sent time to the user.

At a step 750 the operation calculates the time zone of the message center based on the time offset value. Knowing the time offset value and the UTC time of the message center allows the time zone value to be calculated. Thereafter, at a step 754, the operation calculates the message center time, into a desired format, based on the time stamp value, the time offset value and the daylight saving time value. At step 758 the operation displays the message time as the MC time with a time zone identifier. Daylight savings time information may optionally be displayed. Thus, the message recipient is provided the message with data regarding the message center time when the message was sent and the time zone of the message center. If the recipient is receiving a message displayed with time information derived from steps 738 or step 758, and the recipient is in a time zone other than that of the message center, then the recipient may have to perform a calculation to determine the time at which the message was sent as it relates to the time zone associated with their (the recipient's) physical location. This is a significant advantage over the prior art when message recipients were unable to determine when a message was sent.

FIG. 8 illustrates the operation that occurs as a result of advancing to step 716 and 720 as shown in FIG. 7. This exemplary method of operation executes if the system time is known. At a step 804 the mobile station analyzes the time stamp value, the time offset value, the UTC/Local time value and the data in the daylight saving time (D.S.T.) field. Using this information and advancing to step 808, the mobile station determines whether the message center (MC) is set to UTC time or local time. This may occur based on the setting of the UTC/Local time value, which may comprise one or more bits or a flag.

If it is determined that the message center is set to local time, then the mobile station analyzes the time stamp value, the time offset value, and the daylight saving time fields. Based on this analysis the mobile station, at step 816, converts the message center time, as defined by the time stamp, to numeric value corresponding to local time in the location in which mobile station (M.S.) is located. This may be based on the system time, which is known by the mobile station, the time zone of the location in which the mobile station is located, and the time offset value. For example, if the time stamp is 5:00 am Pacific Time the conversion to Eastern Time would yield 8:00 am. Various methods of conversion are available and contemplated.

Next, at a step 820 the mobile station adjusts the local time calculated in step 816 to account for daylight saving time of the location of the message center. Accordingly the message is now displayed or provided to the user with time information defining when the message was sent. In one embodiment it is displayed in the format corresponding to the time zone in which the mobile station is physically located and may optionally provide time zone information and daylight saving time information. Providing time zone information alerts the recipient that the numeric time value is associated with their physical location.

If at step 808 the message center is set to UTC time, the operation progresses to a step 830. At step 830 the mobile station analyzes the time stamp value, the time offset value and the daylight saving time field. Thereafter, at a step 834, the mobile station calculates the time at the message center when the message was sent based on the time stamp, the time offset, and the daylight saving time adjustment information. This may occur by adding the time offset to the time stamp to determine local time of the message center when the message was sent. By calculating the message center time when the message was sent a conversion, at a step 838, may occur to determine the mobile station local time, i.e. the local time in the location in which the mobile station is located. System time and the time offset may also be used for the conversion. This may occur by adding or subtracting the difference between local time of the physical location of the receiving mobile station and the message center.

Thereafter, at a step 842, the message time is displayed with the message to the recipient. Message time is shown with respect to the local time in which the mobile station is physically located at time of receipt. Time zone information and daylight savings time may be shown to make clear to the recipient that the time being displayed is that of local time. For example, if the message was sent at 5:00 pm Pacific Time and the recipient (mobile station) is in the Eastern Time Zone at the time of receipt, then the message sent time will be displayed as “Sent: 8:00 pm Eastern Time Zone”. Thus the recipient is provided the message sent time in a form corresponding to the time zone in which they are located. Further, the time zone associated with the numeric time value may also be displayed.

As an advantage over the prior art, the time displayed as a result of steps 824 and 842 is displayed as the local time of the location in which the message recipient (mobile station) is located. Hence the message recipient is not forced to mentally perform a time zone adjustment calculation to determine when the message was sent. Further, the recipient knows that the time being displayed is that of local time because time zone information, associated with the time value, is also displayed or provided to the recipient.

While various embodiments of the invention have been described, it will be apparent to those of ordinary skill in the art that many more embodiments and implementations are possible that are within the scope of this invention.

What is claimed is:

1. A method for time stamping an electronic message comprising:
receiving an electronic message at a message center;
processing the electronic message to add time data to the electronic message, the time data comprising a time value and a time offset value; and
transmitting the electronic message with the time data to a recipient at a receiving mobile station.

2. The method of claim 1, further comprising:
receiving the electronic message at the receiving mobile station; and
processing the electronic message with the time data to provide to the recipient of the electronic message a time value representing when the message was sent.

3. The method of claim 1, wherein the time data further comprises a UTC/Local time identifier and a daylight savings time identifier.

4. The method of claim 1, wherein the receiving mobile station comprises a wireless telephone.

5. The method of claim 1, wherein processing the electronic message with the time data to provide to the recipient of the electronic message a time value comprises providing the time value in textual form.

6. A method for displaying time information on a mobile communication device to a message recipient to thereby enable the message recipient to determine when a message was sent, the method comprising:
receiving an electronic message, the electronic message including a time stamp value and a time offset value;
processing the time stamp value and the time offset value to determine a message sent time and time zone information associated with the message sent time;
providing the message sent time and the time zone information to the message recipient.

7. The method of claim 6, wherein providing comprises displaying the message sent time and the time zone identifier on a viewable screen in conjunction with message text.

8. The method of claim 6, wherein the time offset value provides information regarding a time zone associated with the time stamp value.

9. The method of claim 6, further comprising:
receiving a local time value from a communication system, the local time value corresponding to a time at a physical location where the mobile communication device is located;
processing the local time value, the time stamp value, and the time offset value to determine the message sent time and time zone information, wherein the message sent time and time zone information are associated with a physical location of mobile communication device.

10. The method of claim 6, wherein processing comprises adding the time offset value to the time stamp value when the time stamp value represents UTC time.

11. A system for time stamping a message comprising:
a receiver configured to receive message data from a message sender;
a processor, in communication with the receiver, configured to:
receive the message data;
create a message shell;
insert time information and the message data into the message shell, the time information comprising a time stamp value and a time zone identifier; and
a transmitter configured to transmit the message shell containing the time information and the message data for receipt by a message recipient;
wherein the time information may be processed at a later time to determine when the message was sent.

12. The system of claim 11, wherein the time zone identifier comprises a time offset value representing an offset from UTC time.

13. The system of claim 11, wherein the system for time stamping comprises a message center.

14. The system of claim 11, wherein the receiver receives the message data over a network link.

15. An electronic message format for an electronic message to a message recipient comprising:
a body field configured to contain a message to the message recipient;
a time field configured to contain information regarding the time setting of an electronic message processing device; and
a time offset field configured to contain information regarding a time zone associated with the time setting.

16. The format of claim 15, wherein the time field is configured to contain data regarding a time when an electronic message was sent.

17. The format of claim 15, wherein the time offset field is configured to contain data regarding a time zone in which the electronic message processing device is located.

18. The format of claim 15, further comprising a daylight savings identifier field configured to contain data regarding a daylight saving adjustment to the time field.

19. A mobile communication device configured to display to a message recipient a message having a time stamp, the mobile communication device comprising:
a receiver configured to receive an electronic message via a wireless link, the electronic message including time data regarding when the message was sent;
a processor in communication with the receiver, the processor configured to analyze the time data and facilitate providing, to a message recipient, information regarding when the message was sent; and
a memory accessible by the processor configured to store processor executable code, wherein the processor executable code is configured to provide a time value and a time zone indicator, responsive to the time data, to the message recipient.

20. The device of claim 19, wherein the mobile communication device is further configured to receive system time and the processor executable code is further configured to process the system time and, responsive to the processing of the system time, display the time value in a format corresponding to the time zone in which the mobile communication device is located at time of receipt of the message.

21. The device of claim 19, wherein the mobile communication device comprises a wireless telephone.

22. The device of claim 19, wherein the time value is adjusted for daylight savings time.
